(19) United States
(12) Patent Application Publication
(10) Pub. No.: US 2026/0049878 A1
(43) Pub. Date: Feb. 19, 2026

(54) PRESSURE SENSOR DEVICE

(71) Applicant: Murata Manufacturing Co., Ltd., Nagaokakyo-shi (JP)

(72) Inventors: Mari Ota, Nagaokakyo-shi (JP); Koichi Yoshida, Nagaokakyo-shi (JP); Mami Uchida, Nagaokakyo-shi (JP)

(21) Appl. No.: 19/371,274

(22) Filed: Oct. 28, 2025

Related U.S. Application Data
(63) Continuation of application No. PCT/JP2024/017650, filed on May 13, 2024.

(30) Foreign Application Priority Data
Jun. 7, 2023 (JP) 2023-094110

(51) Int. Cl. G01L 9/00; G01L 19/00; G01L 19/06

(52) U.S. Cl. CPC G01L 9/0072; G01L 9/0044; G01L 19/0061; G01L 19/0654

(57) ABSTRACT

A pressure sensor device that includes: a membrane layer including a diaphragm portion; a substrate layer facing the membrane layer; a first intermediate layer between the membrane layer and the substrate layer; and a second intermediate layer between the first intermediate layer and the substrate layer. The first intermediate layer includes an electrode portion, and a guard portion joined to a part of the membrane layer different from the diaphragm portion and electrically insulated from the electrode portion. The second intermediate layer includes a side wall portion joined to the substrate layer and the guard portion, and a conductive movable portion supported by the diaphragm portion, apart from the substrate layer and the side wall portion, and in an internal space of the pressure sensor, the movable portion facing and spaced from the electrode portion, the movable portion configured to be moved when the diaphragm portion is displaced.

### The present application is a continuation of International application No. PCT/JP2024/017650, filed May 13, 2024, which claims priority to Japanese Patent Application No. 2023-094110, filed June 7, 2023, the entire contents of each of which are incorporated herein by reference.

### TECHNICAL FIELD

The present disclosure relates to a pressure sensor device configured to perform pressure detection.

### BACKGROUND ART

There have been known pressure sensor devices configured to detect the pressure applied to a diaphragm on the basis of the displacement amount of the diaphragm (see, for example, Patent Documents 1 and 2).

The pressure sensor device disclosed in Patent Document 1 includes a diaphragm having a square shape in plan view, a support portion provided at the center of the square diaphragm, and a movable portion supported by the support portion. As described in detail below, a change in pressure is detected by changing the electrostatic capacity between the movable portion and the diaphragm.

When a pressure is applied to a surface on the opposite side of the diaphragm from a surface on which the support portion is provided, the diaphragm is displaced toward the support portion, and the movable portion moves via the support portion. Here, when a pressure is applied to the diaphragm, the part closer to the center of the diaphragm is more greatly displaced. Thus, application of a pressure to the diaphragm increases the distance between the movable portion supported via the support portion at the center of the diaphragm and the part of the diaphragm other than the center. This results in a reduction in the electrostatic capacity between the movable portion and the diaphragm. The pressure applied to the diaphragm is detected on the basis of the reduction in the electrostatic capacity.

The pressure sensor device disclosed in Patent Document 2 includes a membrane plate configured to be displaced by application of a pressure, and a base electrode facing the membrane plate. When a pressure is applied to the membrane plate, the membrane plate is bent toward the base electrode. This results in an increase in the electrostatic capacity between the membrane plate and the base electrode. The pressure applied to the membrane plate is detected on the basis of the increase in the electrostatic capacity.

In the pressure sensor device disclosed in Patent Document 2, the membrane plate is covered with a passivation film. This prevents foreign matter such as water from being adhered to the membrane plate.

Patent Document 1: Japanese Unexamined Patent Application Publication No. 11-201848

Patent Document 2: International Publication No. 2022/019167

### Summary of the Disclosure

In the pressure sensor device disclosed in Patent Document 1, the diaphragm is exposed to the outside. Thus, foreign matter such as water may be adhered to the diaphragm, and the diaphragm may be affected by disturbance such as electromagnetic waves from the outside. Here, in the pressure sensor device disclosed in Patent Document 1, the diaphragm is an electrode that is configured to form an electrostatic capacity and that is used for performing pressure detection. Thus, a change in the electric potential of the diaphragm due to the adhesion of foreign matter or the disturbance effect described above changes the electrostatic capacity between the movable portion and the diaphragm. This may result in a reduction in the accuracy of pressure detection.

In the pressure sensor device disclosed in Patent Document 2, the passivation film prevents foreign matter from being adhered to the membrane plate. However, in the pressure sensor device disclosed in Patent Document 2, similarly to the diaphragm of the pressure sensor device disclosed in Patent Document 1, the membrane plate is an electrode that is configured to form an electrostatic capacity and that is used for performing pressure detection. Thus, when foreign matter is adhered to the passivation film, a stray capacitance may be formed between the foreign matter and the membrane plate. The stray capacitance may reduce the accuracy of pressure detection.

An object of the present disclosure is to provide a pressure sensor device capable of inhibiting a reduction in the accuracy of pressure detection.

A pressure sensor device according to an aspect of the present disclosure includes: a membrane layer including a diaphragm portion; a substrate layer that faces and is spaced from the membrane layer in a thickness direction; a first intermediate layer between the membrane layer and the substrate layer; and a second intermediate layer between the first intermediate layer and the substrate layer, wherein the first intermediate layer includes: an electrode portion between the diaphragm portion and the second intermediate layer, and a guard portion joined to a part of the membrane layer different from the diaphragm portion and electrically insulated from the electrode portion, and the second intermediate layer includes: a side wall portion joined to the substrate layer and the guard portion, and a conductive movable portion supported by the diaphragm portion, apart from the substrate layer and the side wall portion, positioned in an internal space defined by the diaphragm portion, the substrate layer, and the side wall portion, the conductive movable portion facing and spaced from the electrode portion in the thickness direction, the conductive movable portion configured to be moved when the diaphragm portion is displaced.

According to the present disclosure, it is possible to provide a pressure sensor device capable of inhibiting a reduction in the accuracy of pressure detection.

### BRIEF DESCRIPTION OF THE DRAWINGS

FIG. 1 is a schematic end view of a pressure sensor device according to Embodiment 1 of the present disclosure.

FIG. 2 is a schematic plan view of the part of the pressure sensor device according to Embodiment1 of the present disclosure excluding a membrane layer.

FIG. 3 is a schematic end view of the part of the pressure sensor device according to Embodiment 1 of the present disclosure corresponding to section B-B in FIG. 2.

FIG. 4 is a schematic end view of the part of a modification example of the pressure sensor device according to Embodiment1 of the present disclosure corresponding to section A-A in FIG. 2.

FIG. 5 is a schematic end view of the part of a modification example of the pressure sensor device according to Embodiment 1 of the present disclosure corresponding to section A-A in FIG. 2.

FIG. 6 is a schematic end view of the part of a pressure sensor device according to Embodiment 2 of the present disclosure corresponding to section A-A in FIG. 2.

FIG. 7 is a schematic plan view of the part of a pressure sensor device according to Embodiment 3 of the present disclosure excluding a membrane layer.

FIG. 8 is a schematic end view of the part of the pressure sensor device according to Embodiment 3 of the present disclosure corresponding to section C-C in FIG. 7.

### Description of the Preferred Embodiments

Examples of the present disclosure will be described below with reference to the accompanying drawings. The following description is essentially merely an example and is not intended to limit the present disclosure and the application and use of the present disclosure. In addition, the drawings are schematic, and, for example, size ratios therein do not necessarily coincide with actual ones. In addition, in the following description, terms that mean specific directions or positions (for example, terms including "up", "down", "right", "left", "forward", or "backward") are used as appropriate in some cases. However, such terms that mean specific directions or positions are used to facilitate understanding of the present disclosure with reference to the drawings, and the meanings of these terms do not limit the technical scope of the present disclosure.

Embodiment 1

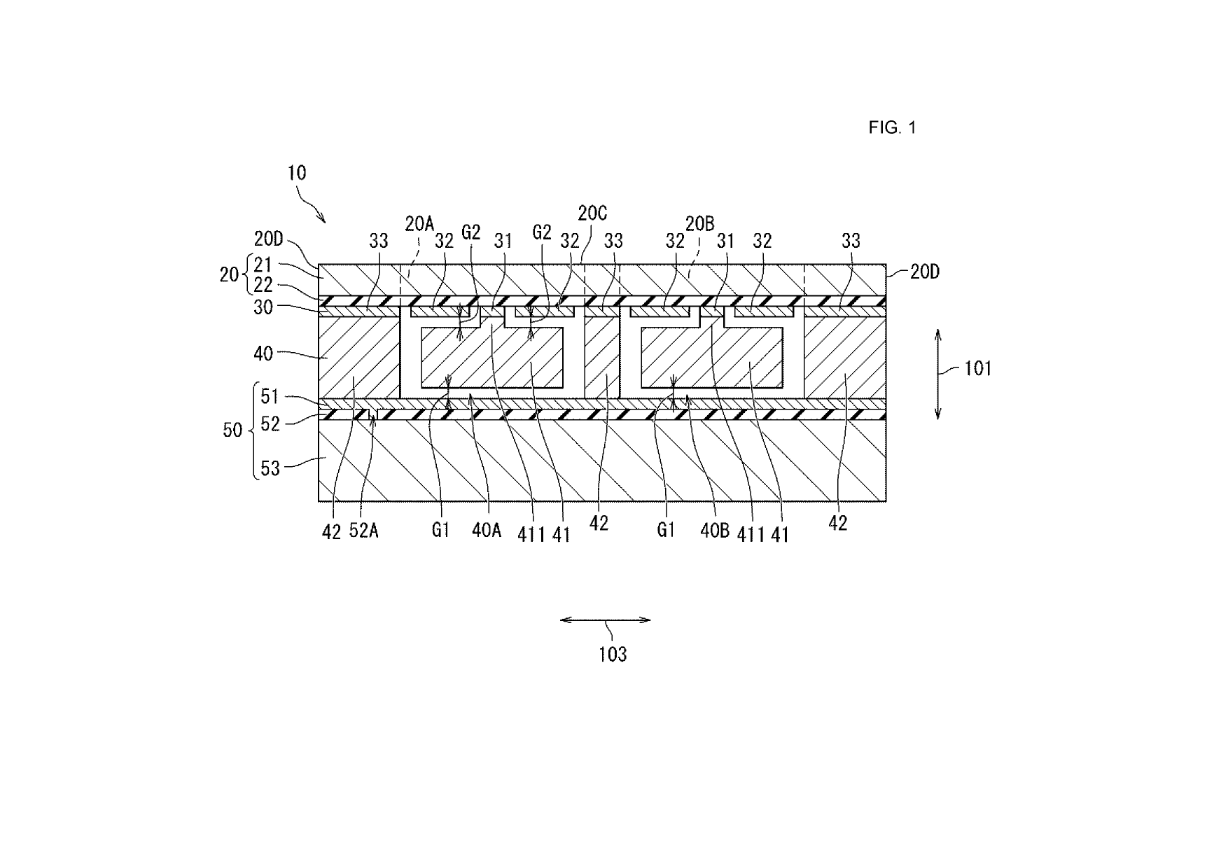

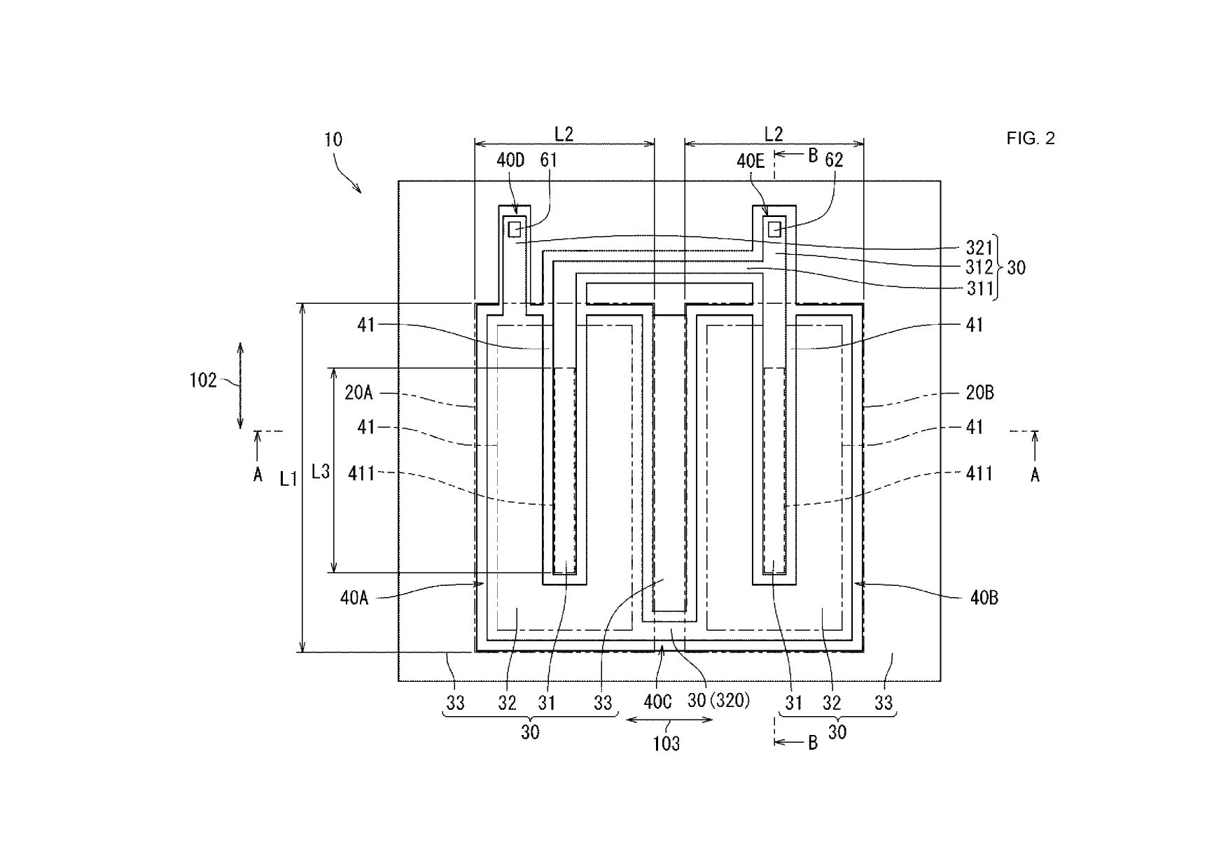

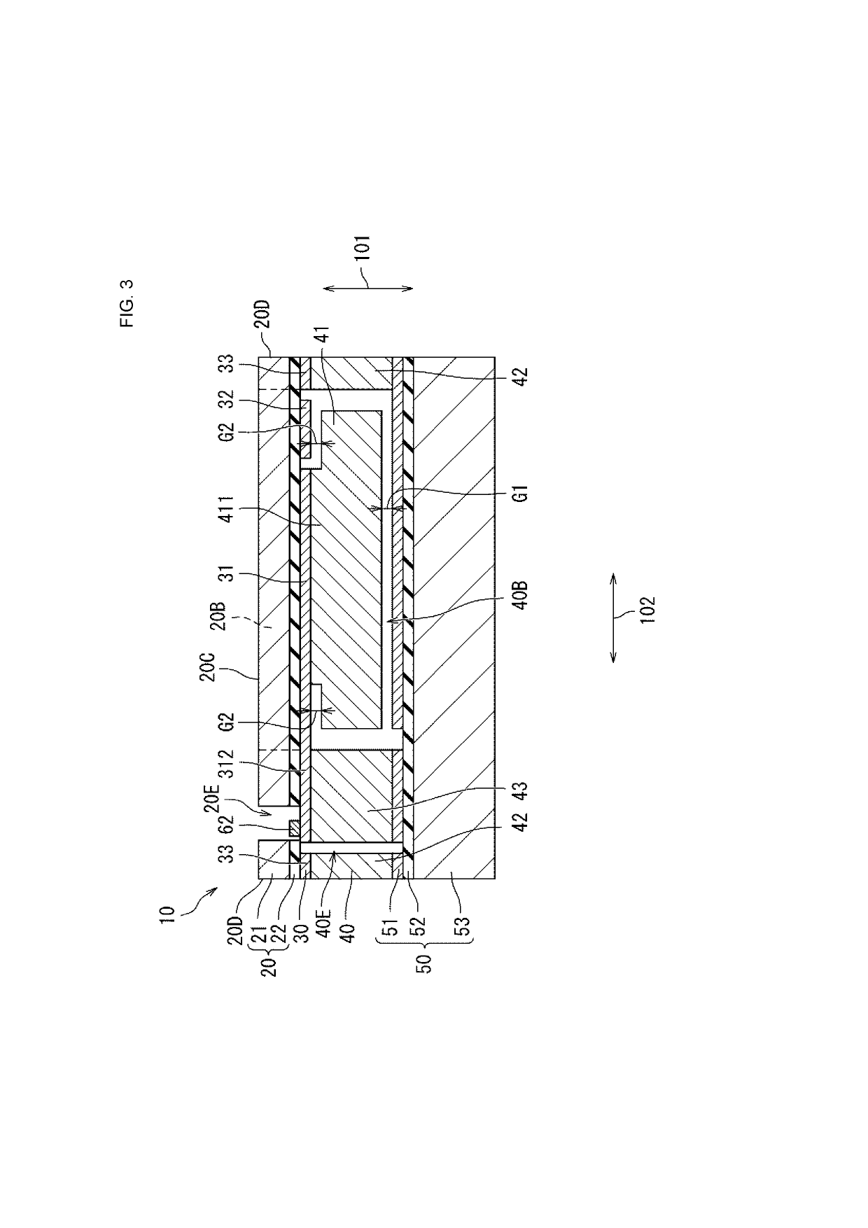

FIG. 1 is a schematic end view of a pressure sensor device according to Embodiment 1 of the present disclosure. FIG. 2 is a schematic plan view of the part of the pressure sensor device according to Embodiment 1 of the present disclosure excluding a membrane layer. FIG. 3 is a schematic end view of the part of the pressure sensor device according to Embodiment 1 of the present disclosure corresponding to section B-B in FIG. 2. FIG. 1 is a schematic end view of the part corresponding to section A-A in FIG. 2.

A pressure sensor device 10 illustrated in FIGS. 1 to 3 is used for pressure detection. The pressure sensor device 10 is an electrostatic capacitive device. In Embodiment 1, the pressure sensor device 10 is a Micro Electro Mechanical Systems (MEMS) device. The pressure sensor device 10 is mounted in, for example, a moving vehicle such as an automobile or a consumer appliance such as a smartphone or a smartwatch.

The pressure sensor device 10 has a cuboid shape. However, the shape of the pressure sensor device 10 is not limited to such a cuboid shape (a quadrilateral shape when viewed in a thickness direction 101). For example, the pressure sensor device 10 may have a polygonal shape other than quadrilateral shapes or a circular cylinder shape when viewed in the thickness direction 101.

As illustrated in FIGS. 1 to 3, the pressure sensor device 10 includes a membrane layer 20, a first intermediate layer 30, a second intermediate layer 40, and a substrate layer 50.

The membrane layer 20 includes a membrane plate 21 and an insulating layer 22 laminated on the membrane plate 21.

In Embodiment 1, the membrane plate 21 has a conductive property and is made of silicon (Si), and the insulating layer 22 has an insulating property and is made of silicon dioxide (SiO₂). In Embodiment 1, the thickness of the membrane plate 21 is 4 μm, and the thickness of the insulating layer 22 is 0.5 μm. The thicknesses are lengths in the thickness direction 101 of the pressure sensor device 10.

The respective materials forming the membrane plate 21 and the insulating layer 22 are not limited to the above materials. For example, the membrane plate 21 may be made of an insulating material such as silicon dioxide (SiO₂). The respective thicknesses of the membrane plate 21 and the insulating layer 22 are not limited to the above thicknesses.

The membrane layer 20 includes a plurality of (two in Embodiment 1) diaphragm portions 20A and 20B. The diaphragm portions 20A and 20B are parts of the membrane layer 20 facing internal spaces 40A and 40B to be described later. The diaphragm portions 20A and 20B are capable of bending. For example, the diaphragm portions 20A and 20B are respectively bent toward the internal spaces 40A and 40B by application of a pressure to one main surface 20C of the membrane layer 20.

In Embodiment 1, as represented by a chain double-dashed line in FIG. 2, each of the diaphragm portions 20A and 20B has a rectangular shape in plan view when viewed in the thickness direction 101. In Embodiment 1, in plan view of each of the diaphragm portions 20A and 20B, the value obtained by dividing a length L1 of a long side of the rectangular shape by a length L2 of a short side of the rectangular shape is two or more. The long side may be longer than the length represented by the chain double-dashed line in FIG. 2, and the short side may be shorter than the length represented by the chain double-dashed line in FIG. 2. As a result, in plan view of each of the diaphragm portions 20A and 20B, the value obtained by dividing the length L1 of the long side of the rectangular shape by the length L2 of the short side of the rectangular shape may be three or more.

In plan view of each of the diaphragm portions 20A and 20B, the value obtained by dividing the length L1 of the long side of the rectangular shape by the length L2 of the short side of the rectangular shape may be less than two. In plan view when viewed in the thickness direction 101, each of the diaphragm portions 20A and 20B may have a shape other than rectangular shapes such as a square shape or a circular shape. In Embodiment 1, in plan view, the diaphragm portions 20A and 20B have the same shape and size but may have different shapes and sizes.

As illustrated in FIG. 2, each of the two diaphragm portions 20A and 20B is disposed such that the long side of the rectangular shape in plan view is parallel to a first direction 102 and the short side of the rectangular shape in plan view is parallel to a second direction 103. The first direction 102 and the second direction 103 are directions orthogonal to the thickness direction 101. The first direction 102 and the second direction 103 are orthogonal to each other. The two diaphragm portions 20A and 20B are arranged in the second direction 103. That is, the two adjacent diaphragm portions 20A and 20B are arranged in the short-side direction of the rectangular shape such that the respective long sides of the rectangular shapes face each other.

The number of diaphragm portions is not limited to two and may be one or three or more. When the pressure sensor device 10 includes three or more diaphragm portions each having a rectangular shape in plan view, adjacent two of the diaphragm portions may be arranged in the short-side direction of the rectangular shape such that the respective long sides of the rectangular shapes face each other.

The one main surface 20C and side surfaces 20D of the membrane layer 20 may be covered with a protective film (not illustrated). The protective film is made of, for example, silicon dioxide (SiO₂) or silicon nitride (SiN).

As illustrated in FIGS. 1 and 3, the substrate layer 50 faces the membrane layer 20 so as to be spaced from each other in the thickness direction 101. The substrate layer 50 includes a conductive layer 51 having a conductive property, an insulating layer 52 having an insulating property, and a substrate 53 having a conductive property. The conductive layer 51 is laminated on the insulating layer 52. The conductive layer 51 faces the internal spaces 40A and 40B. The insulating layer 52 is laminated on the substrate 53. The insulating layer 52 is interposed between the conductive layer 51 and the substrate 53. The conductive layer 51 and the substrate 53 are electrically connected to each other via a through hole 52A formed in the insulating layer 52. The conductive layer 51 does not have to be laminated in the regions of the internal spaces 40A and 40B. In other words, the conductive layer 51 may be laminated only in the region where the conductive layer 51 and the second intermediate layer 40 are joined to each other. In this case, the insulating layer 52 faces the internal spaces 40A and 40B. In addition, either of the conductive layer 51 and the insulating layer 52 does not have to be laminated in the regions of the internal spaces 40A and 40B. In this case, the substrate 53 faces the internal spaces 40A and 40B.

In Embodiment 1, the conductive layer 51 is made of polysilicon (Poly-Si), the insulating layer 52 is made of silicon dioxide (SiO₂), and the substrate 53 is made of silicon (Si). The respective materials forming the conductive layer 51, the insulating layer 52, and the substrate 53 are not limited to the above materials.

The first intermediate layer 30 is located between the membrane layer 20 and the substrate layer 50. The first intermediate layer 30 is joined to the insulating layer 22 of the membrane layer 20. That is, the insulating layer 22 is interposed between the first intermediate layer 30 and the membrane plate 21.

In Embodiment 1, the first intermediate layer 30 has a conductive property and is made of polysilicon (Poly-Si). In Embodiment 1, the thickness of the first intermediate layer 30 is 0.5 μm. The material forming the first intermediate layer 30 is not limited to polysilicon. The thickness of the first intermediate layer 30 is not limited to 0.5 μm.

The first intermediate layer 30 includes connection portions 31, electrode portions 32, and a guard portion 33. The connection portions 31, the electrode portions 32, and the guard portion 33 will be described later.

The second intermediate layer 40 is located between the first intermediate layer 30 and the substrate layer 50. The second intermediate layer 40 includes movable portions 41 and a side wall portion 42.

The side wall portion 42 is joined to the guard portion 33 of the first intermediate layer 30 and the conductive layer 51 of the substrate layer 50.

The side wall portion 42, the insulating layer 22 of the membrane layer 20, and the conductive layer 51 of the substrate layer 50 define the internal spaces 40A to 40E. The movable portions 41 are disposed in the internal spaces 40A and 40B.

As illustrated in FIG. 2, the internal spaces 40A and 40B communicate with each other via the internal spaces 40C and 40E. The internal spaces 40A and 40B do not have to communicate with each other. The internal space 40D communicates with the internal space 40A. The internal space 40E communicates with the internal spaces 40A and 40B.

As illustrated in FIGS. 1 and 2, the internal spaces 40A and 40B in which the movable portions 41 are disposed are respectively provided for the two diaphragm portions 20A and 20B. That is, the pressure sensor device 10 has the two internal spaces 40A and 40B in which the respective movable portions 41 are disposed. The internal space 40A is a space surrounded by the side wall portion 42, the part of the insulating layer 22 included in the diaphragm portion 20A, and the conductive layer 51. The internal space 40B is a space surrounded by the side wall portion 42, the part of the insulating layer 22 included in the diaphragm portion 20B, and the conductive layer 51.

When the pressure sensor device 10 includes a plurality of diaphragm portions, internal spaces are each provided for a corresponding one of the plurality of diaphragm portions. Here, as described above, the number of diaphragm portions is not limited to two. That is, the number of internal spaces in which the movable portions 41 are disposed is not limited to two.

The internal spaces 40A and 40B are closed against the outside of the pressure sensor device 10. That is, the internal spaces 40A and 40B are sealed spaces.

In Embodiment 1, the movable portions 41 are each provided in a corresponding one of the two internal spaces 40A and 40B. That is, in Embodiment 1, the pressure sensor device 10 includes the two movable portions 41 each provided in a corresponding one of the two internal spaces 40A and 40B. One of the two movable portions 41 is provided in the internal space 40A. The other of the two movable portions 41 is provided in the internal space 40B.

As described above, the number of internal spaces in which the movable portions 41 are disposed is not limited to two. That is, the number of movable portions 41 is changed according to the number of internal spaces in which the movable portions 41 are disposed. That is, the number of movable portions 41 is not limited to two.

The movable portions 41 are provided apart from the substrate layer 50 (specifically, the conductive layer 51 of the substrate layer 50) and the side wall portion 42.

In Embodiment 1, the second intermediate layer 40 has a conductive property and is made of silicon (Si). In Embodiment 1, the thickness of the side wall portion 42 is 50 μm, and a gap G1 between each movable portion 41 and the conductive layer 51 is 2 μm. The thickness of each movable portion 41 is thinner than the side wall portion 42 by the gap G1 between each movable portion 41 and the substrate layer 50. The material forming the second intermediate layer 40 is not limited to silicon. The thickness of the side wall portion 42 is not limited to 50 μm. The gap G1 between each movable portion 41 and the conductive layer 51 is not limited to 2 μm.

In Embodiment 1, the first intermediate layer 30 includes the two connection portions 31, the two electrode portions 32, and the one guard portion 33.

As illustrated in FIGS. 1 and 3, the guard portion 33 is joined to the insulating layer 22 of the membrane layer 20 and the side wall portion 42 of the second intermediate layer 40. The guard portion 33 is interposed between the insulating layer 22 and the side wall portion 42. The guard portion 33 is joined to a part of the membrane layer 20 different from the diaphragm portions 20A and 20B.

The guard portion 33, the connection portions 31, and the electrode portions 32 are provided apart from each other. The guard portion 33, the connection portions 31, and the electrode portions 32 are electrically insulated from each other.

Each of the connection portions 31 and each of the electrode portions 32 are provided in a corresponding one of the plurality of internal spaces. One of the two connection portions 31 and one of the two electrode portions 32 are provided in the internal space 40A. The other of the two connection portions 31 and the other of the two electrode portions 32 are provided in the internal space 40B. The one of the two connection portions 31 and the one of the two electrode portions 32 are joined to the diaphragm portion 20A. The other of the two connection portions 31 and the other of the two electrode portions 32 are joined to the diaphragm portion 20B.

When the pressure sensor device 10 has a plurality of internal spaces, the movable portions are each provided in a corresponding one of the plurality of internal spaces. Here, as described above, the number of internal spaces is not limited to two. That is, the number of connection portions 31 is not limited to two, and the number of electrode portions 32 is not limited to two.

The configuration of the connection portion 31 and the electrode portion 32 provided in the internal space 40A is the same as the configuration of the connection portion 31 and the electrode portion 32 provided in the internal space 40B. Thus, the configuration of the connection portion 31 and the electrode portion 32 provided in the internal space 40A will be described below. The description of the configuration of the connection portion 31 and the electrode portion 32 provided in the internal space 40B is basically omitted and is given as appropriate.

The connection portion 31 and the electrode portion 32 are located between the diaphragm portion 20A of the membrane layer 20 and the second intermediate layer 40 in the thickness direction 101. The connection portion 31 and the electrode portion 32 are joined to the part of the diaphragm portion 20A of the insulating layer 22 of the membrane layer 20.

The connection portion 31 is joined to a support portion 411 provided to the movable portion 41 of the second intermediate layer 40. The support portion 411 is a projection provided to the movable portion 41 and projects from the movable portion 41 to the connection portion 31 in the thickness direction 101. Here, as described above, the connection portion 31 is joined to the diaphragm portion 20A. That is, the diaphragm portion 20A supports the movable portion 41 via the connection portion 31. In other words, the support portion 411 is the part of the movable portion 41 supported by the diaphragm portion 20A.

As illustrated in FIG. 2, the connection portion 31 and the support portion 411 are located at the intermediate position in the short-side direction (the second direction 103) of the diaphragm portion 20A having the rectangular shape when viewed in the thickness direction 101 and extend in the long-side direction (the first direction 102) of the rectangular shape. That is, the connection portion 31 and the support portion 411 have linear shapes extending in the first direction 102 at the intermediate position of the diaphragm portion 20A in the second direction 103.

The support portion 411 is supported by the diaphragm portion 20A via the connection portion 31 at the position where the displacement amount of the diaphragm portion 20A when a pressure is applied to the diaphragm portion 20A is maximum.

This will be described in detail below. In the diaphragm portion 20A having the rectangular shape when viewed in the thickness direction 101, the displacement amount is small at the outer edge portion of the rectangular shape. The displacement amount increases with increasing the distance from the outer edge portion when viewed in the thickness direction 101. In Embodiment 1, the support portion 411 is supported by the diaphragm portion 20A at the position where the displacement amount is maximum. In Embodiment 1, the respective end portions of the support portion 411 in the first direction 102 do not reach the ends of the diaphragm portion 20A in the first direction 102.

In Embodiment 1, the value obtained by dividing a length (length in the first direction 102) L3 of a long side of the rectangular shape of the support portion 411 in plan view by the length (length in the first direction 102) L1 of the long side of the rectangular shape of the diaphragm portion 20A in plan view is 0.1 to 0.75. Preferably, the value obtained by dividing the length L3 by the length L1 is 0.5 to 0.7. In Embodiment 1, the value obtained by dividing the length (length in the second direction 103) of a short side of the rectangular shape of the support portion 411 in plan view by the length (length in the second direction 103) of the short side of the rectangular shape of the diaphragm portion 20A in plan view is 0.05 to 0.5. Preferably, this value is 0.07 to 0.15.

As illustrated in FIGS. 1 and 3, the electrode portion 32 faces and is spaced from the movable portion 41 in the thickness direction 101. In Embodiment 1, a gap G2 between the electrode portion 32 and the movable portion 41 is 0.2 μm. However, the gap G2 between the electrode portion 32 and the movable portion 41 is not limited to 0.2 μm.

As illustrated in FIG. 2, the electrode portion 32 is provided so as to surround the support portion 411 when viewed in the thickness direction 101.

The electrode portion 32 provided in the internal space 40A and the electrode portion 32 provided in the internal space 40B are electrically connected to each other via a communication portion 320. The electrode portion 32 provided in the internal space 40A can be electrically connected to the outside of the pressure sensor device 10 via a communication portion 321 and a terminal 61. The terminal 61 is used for electrically connecting the electrode portions 32 to the outside of the pressure sensor device 10. Similarly to a terminal 62 to be described later, the terminal 61 is exposed to the outside. The communication portion 321 is supported by a first support wall portion (not illustrated) included in the second intermediate layer 40. The first support wall portion is electrically connected to the electrode portions 32 via the communication portion 321. On the other hand, the first support wall portion is apart from and electrically insulated from the connection portions 31 and the guard portion 33.

As illustrated in FIGS. 2 and 3, the respective movable portions 41 provided in the internal spaces 40A and 40B are electrically connected to the connection portions 31 via the support portions 411. The connection portion 31 provided in the internal space 40A can be electrically connected to the outside of the pressure sensor device 10 via a communication portion 311 and the terminal 62. The connection portion 31 provided in the internal space 40B can be electrically connected to the outside of the pressure sensor device 10 via a communication portion 312 and the terminal 62. The terminal 62 is used for electrically connecting the movable portions 41 to the outside of the pressure sensor device 10. The terminal 62 is exposed to the outside through a cavity 20E formed in the membrane layer 20 (see FIG. 3). The communication portions 311 and 312 are supported by a second support wall portion 43 included in the second intermediate layer 40. The second support wall portion 43 is electrically connected to the connection portions 31 via the communication portions 311 and 312. On the other hand, the second support wall portion 43 is apart from and electrically insulated from the electrode portions 32 and the guard portion 33.

As illustrated in FIG. 1, the electrical connection described above forms a capacitor having the gap G2 between the electrode portion 32 and the movable portion 41 in each of the internal spaces 40A and 40B.

When a pressure is applied to the one main surface 20C of the membrane layer 20, the diaphragm portions 20A and 20B of the membrane layer 20 are bent toward the substrate layer 50 in the thickness direction 101. In other words, when a pressure is applied to the one main surface 20C of the membrane layer 20, the diaphragm portions 20A and 20B of the membrane layer 20 are displaced toward the substrate layer 50 in the thickness direction 101. The displacement of the diaphragm portions 20A and 20B moves the movable portions 41 and the electrode portions 32 joined to the diaphragm portions 20A and 20B.

As described above, the movable portion 41 including the support portion 411 is supported by the diaphragm portion 20A at the position where the displacement amount of the diaphragm portion 20A when a pressure is applied to the diaphragm portion 20A is maximum. On the other hand, the electrode portion 32 is joined to the membrane layer 20 around the support portion 411. That is, the electrode portion 32 is joined to the membrane layer 20 at a position where the displacement amount of the diaphragm portion 20A when a pressure is applied to the diaphragm portion 20A is not maximum. Thus, when the membrane layer 20 is bent, the movement amount of the movable portion 41 in the thickness direction 101 is larger than the movement amount of the electrode portion 32 in the thickness direction 101. Accordingly, application of a pressure to the diaphragm portion 20A increases the gap G2 between the electrode portion 32 and the movable portion 41. As a result, the electrostatic capacity of the capacitor changes. The pressure applied to the membrane layer 20 is detected on the basis of the electrostatic capacity change.

According to Embodiment 1, the diaphragm portions 20A and 20B of the membrane layer 20 do not function as electrodes that are configured to form an electrostatic capacity and that are used for performing pressure detection. The electrode portions 32 of the first intermediate layer 30 and the movable portions 41 of the second intermediate layer 40 function as electrodes that are configured to form an electrostatic capacity and that are used for performing pressure detection. The displacement of the diaphragm portions 20A and 20B subjected to a pressure moves the movable portions 41. A change in pressure is detected by changing the electrostatic capacity between the electrode portion 32 and the movable portion 41 in this case. Here, the movable portions 41 are located in the internal spaces 40A and 40B. In addition, between the second intermediate layer 40 and the diaphragm portions 20A and 20B, the electrode portions 32 face and are spaced from the movable portions 41 in the thickness direction 101. That is, the electrode portions 32 are also located in the internal spaces 40A and 40B. Thus, it is possible to inhibit adhesion of foreign matter such as water from the outside to the electrode portions 32 and the movable portions 41 and to reduce the effect of disturbance such as electromagnetic waves on the electrode portions 32 and the movable portions 41. As a result, it is possible to inhibit a reduction in the accuracy of pressure detection.

According to Embodiment 1, both the electrode portions 32 and the guard portion 33 of the first intermediate layer 30 are joined to the membrane layer 20. Thus, a step of laminating the membrane layer 20 and the first intermediate layer 30 in the manufacturing process of the pressure sensor device 10 can be performed easier than a step of laminating the membrane layer 20 and the first intermediate layer 30 in the configuration in which one of each electrode portion 32 and the guard portion 33 is joined to the membrane layer 20 whereas the other of each electrode portion 32 and the guard portion 33 is not joined to the membrane layer 20.

According to Embodiment 1, the diaphragm portions 20A and 20B support the movable portions 41 at the positions where the displacement amount of the diaphragm portions 20A and 20B when a pressure is applied to the diaphragm portions 20A and 20B is maximum. Thus, it is possible to increase the movement amount of the movable portions 41 when a pressure is applied to the diaphragm portions 20A and 20B. As a result, it is possible to increase the change in the distance between the movable portions 41 and the electrode portions 32 and to thus increase the accuracy of pressure detection.

According to Embodiment 1, the internal spaces 40A and 40B may be sealed spaces. In this case, it is possible to prevent foreign matter from being adhered to the electrode portions 32 and the movable portions 41.

In the configuration in which a diaphragm portion has a square shape when viewed in the thickness direction 101, when a pressure is applied to the diaphragm portion, the displacement amount of the diaphragm portion is maximum at the center point of the square shape and reduces with increasing the distance from the center. On the other hand, in the configuration in Embodiment 1 in which the diaphragm portions 20A and 20B each have the rectangular shape when viewed in the thickness direction 101, when a pressure is applied to the diaphragm portions 20A and 20B, the displacement amount of the diaphragm portions 20A and 20B is maximum at the center in the short-side direction of the rectangular shape and reduces with increasing the distance from the center. The part where the displacement amount is maximum extends along the long side of the rectangular shape. That is, in the configuration in which the diaphragm portions 20A and 20B each have the rectangular shape when viewed in the thickness direction 101, the part of each of the diaphragm portions 20A and 20B where the displacement amount is maximum does not have a point-like shape but has a linear shape. That is, compared with the configuration in which a diaphragm portion has a square shape when viewed in the thickness direction 101, the configuration in which the diaphragm portions 20A and 20B each have the rectangular shape when viewed in the thickness direction 101 enables an increase in the regions of the diaphragm portions 20A and 20B where the displacement amount is uniform.

When the movable portions 41 are supported in the regions of the diaphragm portions 20A and 20B where the displacement amount is uniform, the movement of the movable portions 41 arising from the displacement of the diaphragm portions 20A and 20B is stable. As a result, it is possible to make the change in the distance between the movable portions 41 and the electrode portions 32 stable and to thus inhibit a reduction in the accuracy of pressure detection. Compared with the configuration in which the diaphragm portions 20A and 20B each have a square shape when viewed in the thickness direction 101, Embodiment 1 enables an increase in the regions of the diaphragm portions 20A and 20B where the displacement amount is uniform. Thus, it is possible to increase the regions of the diaphragm portions 20A and 20B supporting the movable portions 41. Accordingly, it is possible to increase the strength for supporting the movable portions 41. As described above, according to Embodiment 1, it is possible to increase the strength for supporting the movable portions 41 while inhibiting a reduction in the accuracy of pressure detection.

Variations in the manufacturing process of a pressure sensor device may cause a shift of the position where a support portion supports a diaphragm portion from the proper position. In this case, the displacement of a movable portion when a pressure is applied to the diaphragm portion may differ from the proper displacement. For example, as in the pressure sensor device disclosed in Patent Document 1, when a support portion is formed at the center of a diaphragm portion having a square shape, the following problem may arise. That is, when the position where the support portion supports the diaphragm portion is shifted in a direction from the center, the displacement of a movable portion when a pressure is applied to the diaphragm portion may be displacement in a direction inclined relative to the thickness direction instead of the proper displacement (displacement in the thickness direction). This may reduce the accuracy of pressure detection. That is, the configuration in which the support portion is formed at the center of the diaphragm portion having the square shape may reduce the accuracy of pressure detection regardless of the direction in which the position of the support portion is shifted.

In Embodiment 1, the support portions 411 each have a linear shape extending in the long-side direction of the diaphragm portions 20A and 20B each having the rectangular shape when viewed in the thickness direction 101. In this case, even when the positions of the support portions 411 relative to the diaphragm portions 20A and 20B are shifted in the long-side direction, the displacement of the movable portions 41 when a pressure is applied to the diaphragm portions 20A and 20B is inhibited from being displacement in a direction inclined relative to the thickness direction 101. That is, the configuration in which the support portion is formed at the center of the diaphragm portion having the rectangular shape can inhibit a reduction in the accuracy of pressure detection depending on the direction in which the position of the support portion is shifted. As described above, compared with the configuration in which the support portion is formed at the center of the diaphragm portion having the square shape, Embodiment 1 can inhibit a reduction in the accuracy of pressure detection.

According to Embodiment 1, the value obtained by dividing the length of the long side of each of the diaphragm portions 20A and 20B having the rectangular shape when viewed in the thickness direction 101 by the length of the short side of each of the diaphragm portions 20A and 20B is two or more. The long side of the rectangular shape in this case is longer than a long side of a rectangular shape of a diaphragm portion having the same area as the above rectangular shape in a configuration in which the above value is less than two. Thus, according to Embodiment 1, it is possible to increase the size of the part of each of the diaphragm portions 20A and 20B where the displacement amount is maximum (part extending along the long side of the rectangular shape).

According to Embodiment 1, the value obtained by dividing the length of the long side of the diaphragm portion having the rectangular shape when viewed in the thickness direction 101 by the length of the short side of the diaphragm portion may be three or more. The long side of the rectangular shape in this case is longer than a long side of a rectangular shape of a diaphragm portion having the same area as the above rectangular shape in a configuration in which the above value is less than three. Thus, according to Embodiment 1, it is possible to increase the size of the part of each of the diaphragm portions 20A and 20B where the displacement amount is maximum (part extending along the long side of the rectangular shape).

According to Embodiment 1, the plurality of diaphragm portions 20A and 20B are arranged in the short-side direction of the rectangular shape such that the respective long sides of the rectangular shapes of the adjacent two diaphragm portions 20A and 20B face each other. Thus, it is possible to make the difference in length between the long sides and the short sides of the entire diaphragm portions 20A and 20B smaller than the difference in length between the long side and the short side of a diaphragm portion having a rectangular shape and having the same area as the total area of the diaphragm portions 20A and 20B when viewed in the thickness direction 101. That is, it is possible to make the shape of the pressure sensor device 10 approaching a square shape, which is a stable shape, when viewed in the thickness direction 101. As a result, compared with the configuration including a diaphragm portion having a rectangular shape (more unstable shape than a square shape) when viewed in the thickness direction 101, Embodiment 1 can facilitate mounting of the pressure sensor device 10 on a board and can reduce warpage of the pressure sensor device 10.

According to Embodiment 1, an internal space having a large volume is formed compared with the configuration in which the plurality of internal spaces 40A and 40B do not communicate with each other. Thus, it is possible to reduce variations in the manufacturing of the pressure sensor device 10 due to the internal pressure of the internal space. As a result, it is possible to reduce variations in pressure detection characteristics among manufactured pressure sensor devices 10.

### Modification Examples

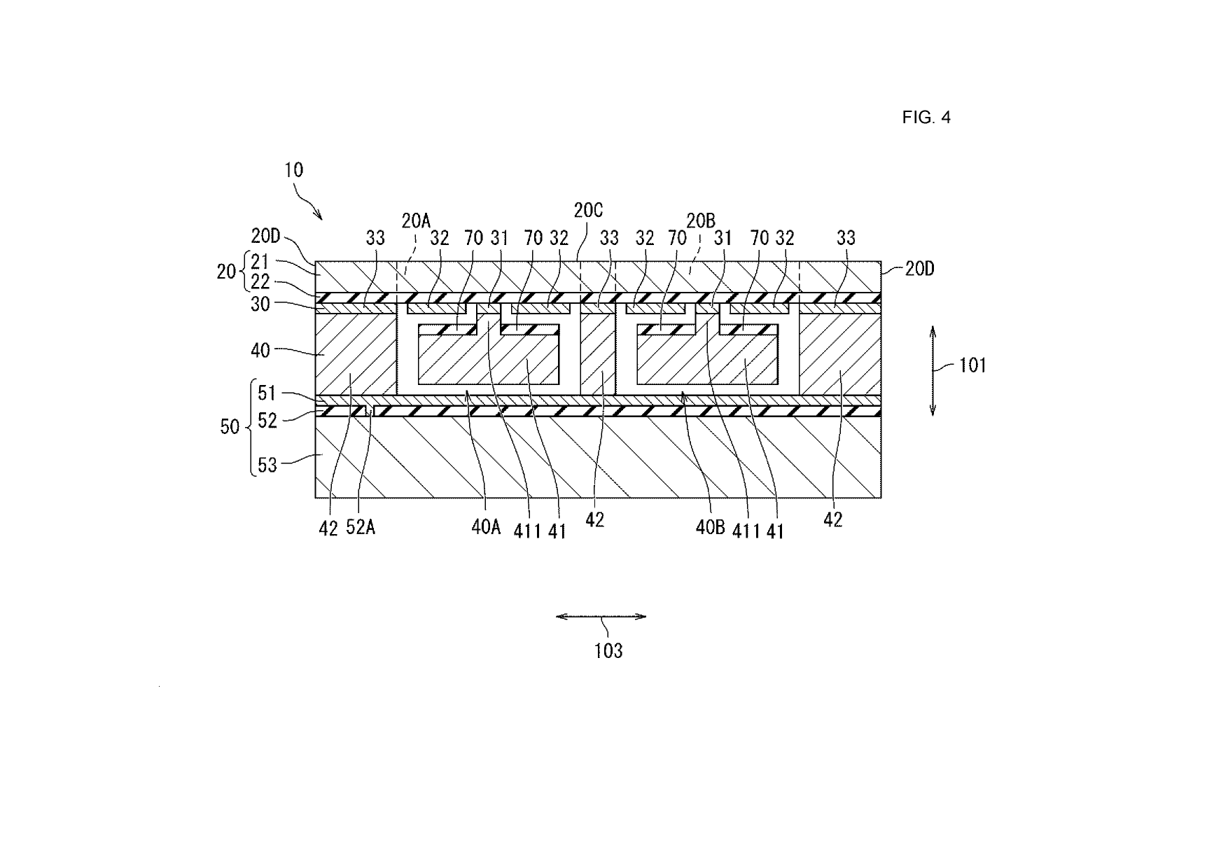

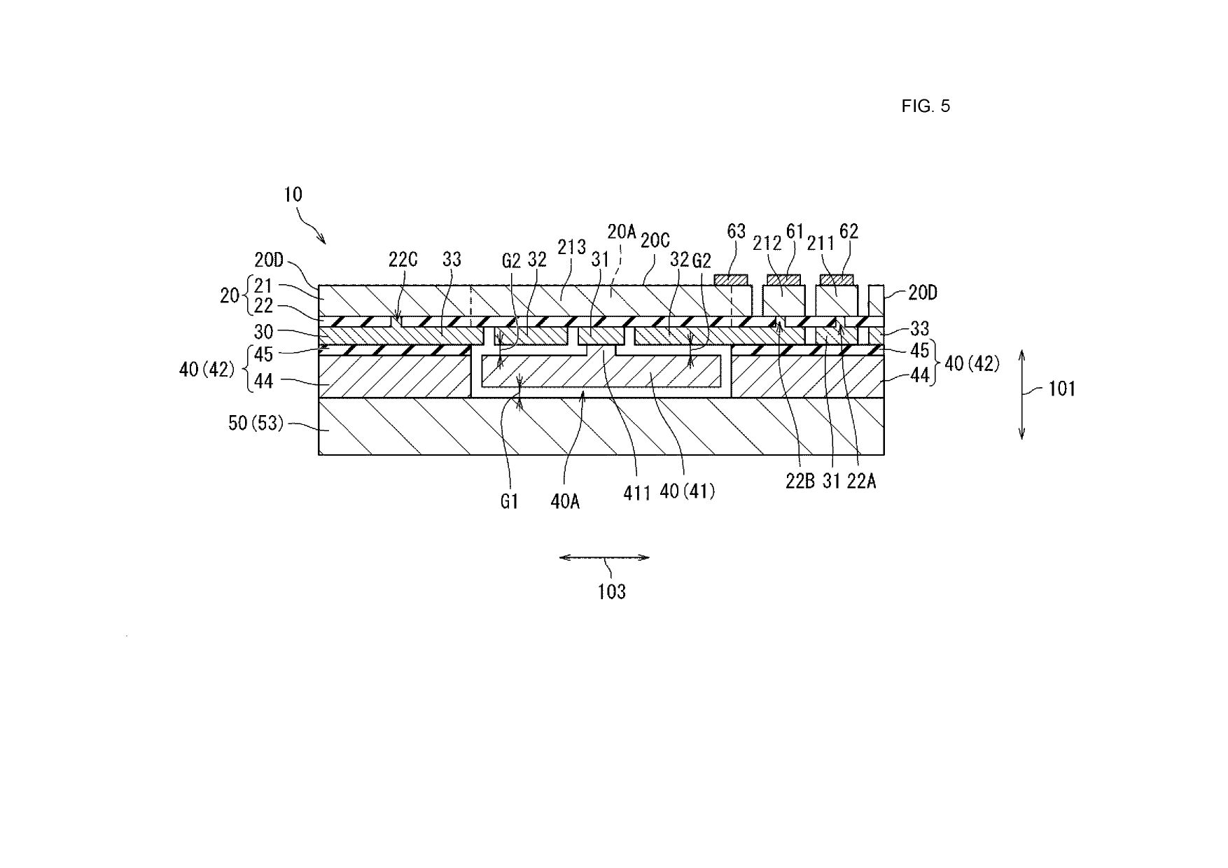

FIG. 4 is a schematic end view of the part of a modification example of the pressure sensor device according to Embodiment 1 of the present disclosure corresponding to section A-A in FIG. 2. FIG. 5 is a schematic end view of the part of a modification example of the pressure sensor device according to Embodiment 1 of the present disclosure corresponding to section A-A in FIG. 2. The modification examples will be described below as modification examples of the pressure sensor device according to Embodiment 1 but may be used as modification examples of the pressure sensor devices according to Embodiments 2 and 3.

The configuration of each layer of the pressure sensor device 10 is not limited to the configuration illustrated in FIGS. 1 to 3.

For example, as illustrated in FIG. 4, the pressure sensor device 10 may include an insulating layer 70 having an insulating property and laminated on at least part of the region of an upper surface of each of the movable portions 41 excluding the parts where the support portions 411 are provided. The material forming the insulating layer 70 is, for example, silicon dioxide (SiO₂) or silicon nitride (SiN). Naturally, the material forming the insulating layer 70 may be a material other than silicon dioxide (SiO₂) and silicon nitride (SiN).

In addition, for example, as illustrated in FIG. 5, the side wall portion 42 of the second intermediate layer 40 of the pressure sensor device 10 may include a conductive layer 44 having a conductive property, and an insulating layer 45 having an insulating property, laminated on the conductive layer 44, and joined to the first intermediate layer 30. In addition, for example, as illustrated in FIG. 5, the substrate layer 50 of the pressure sensor device 10 may include only the substrate 53 without the conductive layer 51 and the insulating layer 52.

In addition, for example, as illustrated in FIG. 5, the terminals 61 and 62 may be provided on the membrane plate 21. In this case, the membrane plate 21 includes plates 211, 212, and 213 insulated from each other. The terminal 61 is provided on the plate 212. The terminal 62 is provided on the plate 211. The connection portion 31 is electrically connected to the terminal 62 via a through hole 22A formed in the insulating layer 22. The electrode portion 32 is electrically connected to the terminal 61 via a through hole 22B formed in the insulating layer 22. Parts of the connection portion 31 illustrated at a plurality of positions in FIG. 5 are connected to each other at different positions in the figure depth direction in FIG. 5.

The pressure sensor device 10 illustrated in FIG. 5 may further include a terminal 63. The terminal 63 is provided on the plate 213. The guard portion 33 is electrically connected to the terminal 63 via a through hole 22C formed in the insulating layer 22.

The pressure sensor device 10 in the modification example illustrated in FIG. 5 includes the one diaphragm portion 20A, the one internal space 40A, the one movable portion 41, the one connection portion 31, and the one electrode portion 32. This agrees with the above description in which each of the numbers of internal spaces 40A, movable portions 41, connection portions 31, and electrode portions 32 is not limited to two.

Embodiment 2

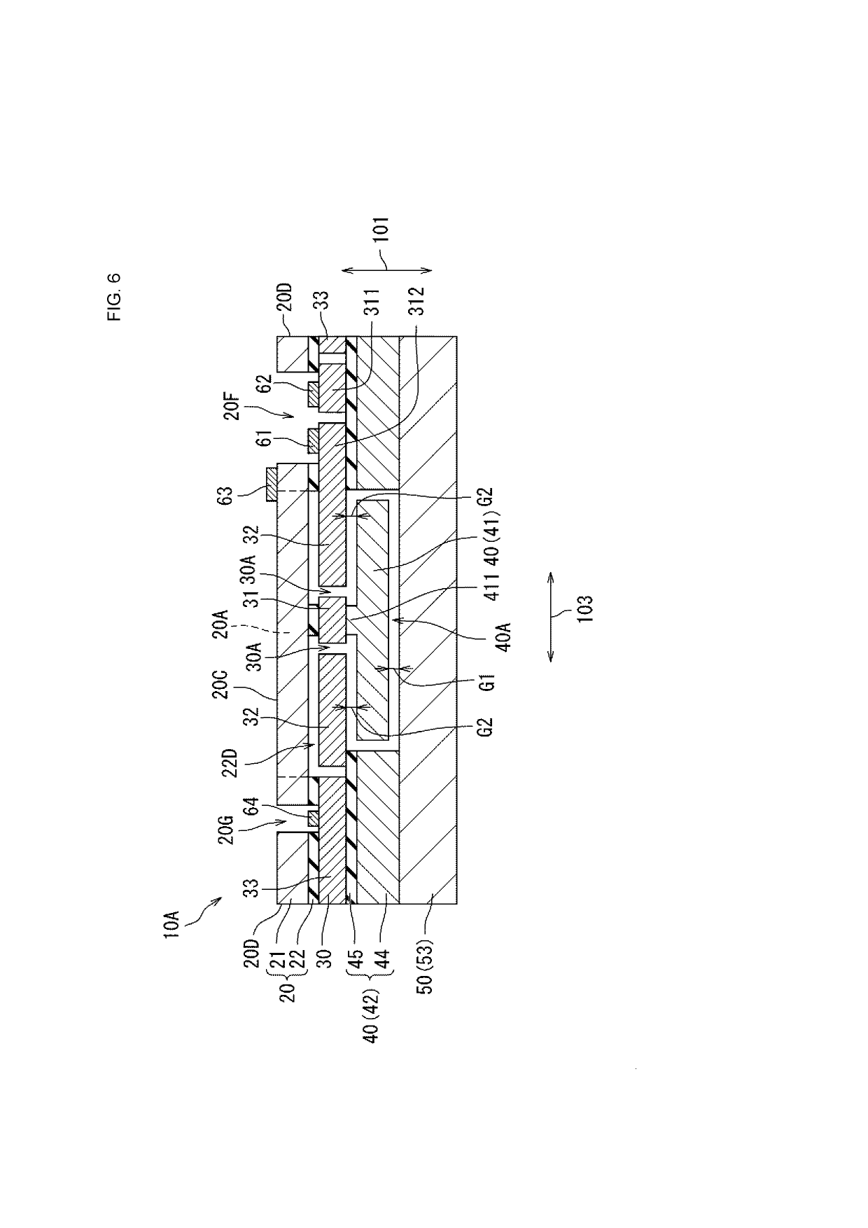

FIG. 6 is a schematic end view of the part of a pressure sensor device according to Embodiment 2 of the present disclosure corresponding to section A-A in FIG. 2. A pressure sensor device 10A according to Embodiment 2 differs from the pressure sensor device 10 according to Embodiment 1 in that an electrode portion is apart from a diaphragm portion and that the electrode portion is supported by a side wall portion. The differences between Embodiment 1 and Embodiment 2 will be described below. The parts that are the same as those of the pressure sensor device 10 according to Embodiment 1 have the same reference signs, and descriptions thereof are basically omitted and given as appropriate.

Similarly to the pressure sensor device 10 illustrated in FIG. 5, the pressure sensor device 10A illustrated in FIG. 6 includes the one diaphragm portion 20A, the one internal space 40A, the one movable portion 41, the one connection portion 31, and the one electrode portion 32. In addition, the pressure sensor device 10A includes the conductive layer 44 and the insulating layer 45 similarly to the side wall portion 42 of the second intermediate layer 40 of the pressure sensor device 10 illustrated in FIG. 5.

As illustrated in FIG. 6, the electrode portion 32 is not joined to the diaphragm portion 20A of the membrane layer 20. The insulating layer 22 is not formed immediately above the electrode portion 32. The electrode portion 32 faces the membrane plate 21 of the membrane layer 20 in the thickness direction 101 via a gap 22D. The gap 22D communicates with the internal space 40A via a gap 30A between the connection portion 31 and the electrode portion 32.

The electrode portion 32 includes a part that faces and is spaced from the movable portion 41 in the thickness direction 101, and a part that does not face the movable portion 41 in the thickness direction 101. The part of the electrode portion 32 that does not face the movable portion 41 in the thickness direction 101 is joined to the insulating layer 45 of the side wall portion 42. Thus, the electrode portion 32 is supported by the side wall portion 42.

Similarly to the pressure sensor device 10 according to Embodiment 1, the connection portion 31 and the guard portion 33 are joined to the insulating layer 22 of the membrane layer 20.

The terminals 61 and 62 are exposed to the outside through a cavity 20F formed in the membrane layer 20. The terminal 63 is provided on the membrane plate 21. The pressure sensor device 10A illustrated in FIG. 6 further includes a terminal 64. The terminal 64 is provided on the guard portion 33 of the first intermediate layer 30. The terminal 64 is exposed to the outside through a cavity 20G formed in the membrane layer 20.

According to Embodiment 2, the movable portion 41 supported by the diaphragm portion 20A is moved in the thickness direction 101 by displacing the diaphragm portion 20A. On the other hand, the electrode portion 32 apart from the diaphragm portion 20A is not moved by displacing the diaphragm portion 20A. Accordingly, when the movable portion 41 is moved, the electrode portion 32 and the movable portion 41 are kept parallel to each other, thus inhibiting a reduction in the accuracy of pressure detection. On the other hand, in the case of the configuration in which the electrode portion 32 is joined to the diaphragm portion 20A, when a pressure is applied to the diaphragm portion 20A, the electrode portion 32 is bent together with the diaphragm portion 20A. Thus, the electrode portion 32 and the movable portion 41 are not kept parallel to each other. This may result in a reduction in the accuracy of pressure detection. As described above, compared with the configuration in which the electrode portion 32 is joined to the diaphragm portion 20A, Embodiment 2 can inhibit a reduction in the accuracy of pressure detection.

Embodiment 3

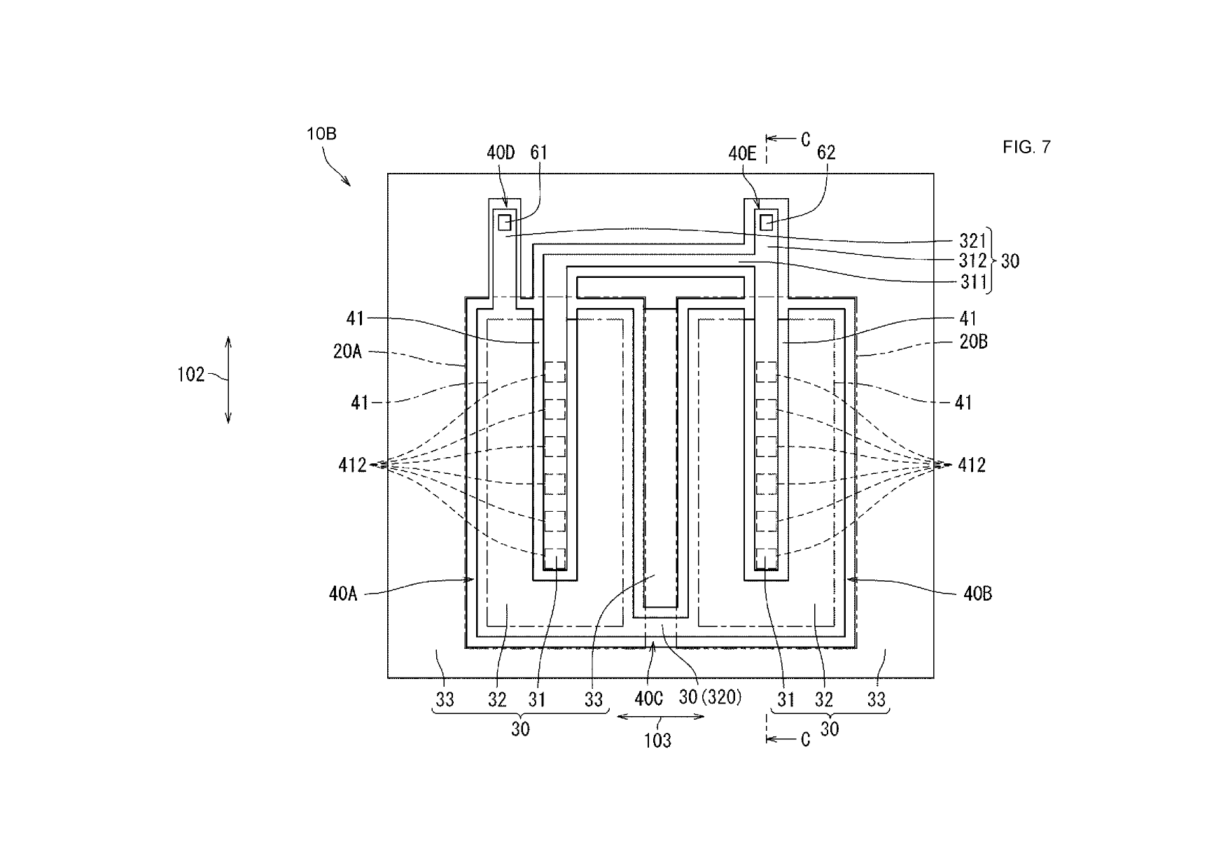

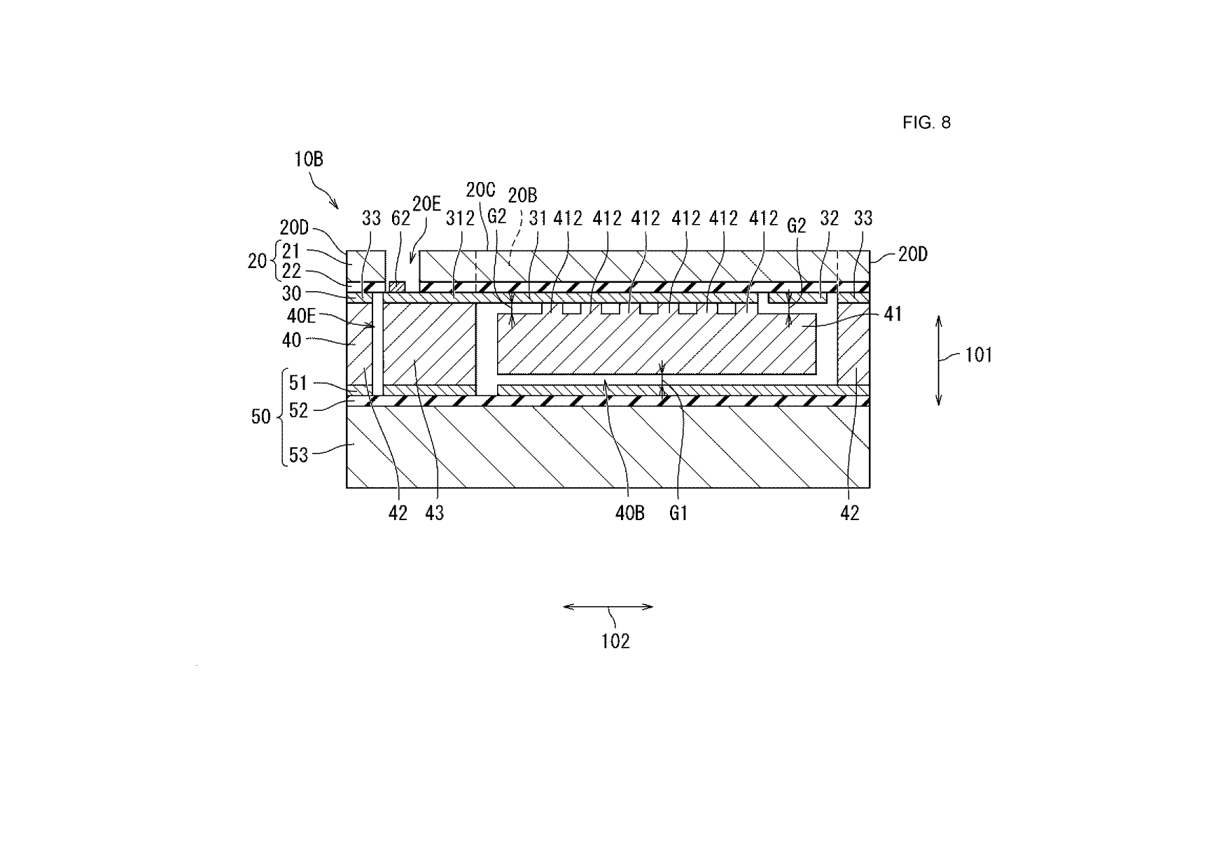

FIG. 7 is a schematic plan view of the part of a pressure sensor device according to Embodiment 3 of the present disclosure excluding a membrane layer. FIG. 8 is a schematic end view of the part of the pressure sensor device according to Embodiment 3 of the present disclosure corresponding to section C-C in FIG. 7. A pressure sensor device 10B according to Embodiment 3 differs from the pressure sensor device 10 according to Embodiment 1 in that the movable portion 41 includes a plurality of support portions 412. The differences between Embodiment 1 and Embodiment 3 will be described below. The parts that are the same as those of the pressure sensor device 10 according to Embodiment 1 have the same reference signs, and descriptions thereof are basically omitted and given as appropriate.

As illustrated in FIGS. 7 and 8, the movable portion 41 includes the plurality of support portions 412 instead of the one support portion 411. Each of the plurality of support portions 412 is a projection provided to the movable portion 41 and projects from the movable portion 41 to the connection portion 31 in the thickness direction 101. Each of the plurality of support portions 412 is joined to the connection portion 31. In Embodiment 3, the diaphragm portions 20A and 20B each support the movable portion 41 via the connection portion 31 and the plurality of support portions 412. In other words, each of the plurality of support portions 412 is the part of each of the movable portions 41 supported by the diaphragm portions 20A and 20B.

Similarly to the support portion 411 included in the pressure sensor device 10 according to Embodiment 1, the plurality of support portions 412 are supported by the diaphragm portions 20A and 20B via the connection portions 31 at the positions where the displacement amount of the diaphragm portions 20A and 20B when a pressure is applied to the diaphragm portions 20A and 20B is maximum.

The plurality of support portions 412 are arranged spaced from each other in the long-side direction (the first direction 102) of the diaphragm portions 20A and 20B each having the rectangular shape when viewed in the thickness direction 101.

In the pressure sensor device 10B illustrated in FIGS. 7 and 8, one movable portion 41 is disposed in each of the internal spaces 40A and 40B. However, a plurality of movable portions 41 may be disposed in each of the internal spaces 40A and 40B. In this case, each of the plurality of movable portions 41 may include one support portion 412 or may include a plurality of support portions 412. For example, three movable portions 41 may be disposed in the internal space 40A. In this case, each of the three movable portions 41 may include the one support portion 412 or may include the plurality of support portions 412.

The plurality of movable portions 41 disposed in the internal spaces 40A and 40B may each include a different number of support portions 412. For example, when three movable portions 41 are disposed in the internal space 40A, one of the three movable portions 41 may include a plurality of support portions 412, and the other two of the three movable portions 41 may each include one support portion 412.

According to Embodiment 3, the plurality of support portions 412 are arranged spaced from each other. Thus, the diaphragm portions 20A and 20B supporting the support portions 412 are easily bent compared with the configuration in which the one support portion 411 extends linearly. As a result, the movable portions 41 move easily, thus enabling an increase in the accuracy of pressure detection.

According to Embodiment 3, the plurality of support portions 412 are arranged in the long-side direction. Thus, similarly to the configuration in which the one support portion 411 extends in the long-side direction, the movable portion 41 is inhibited from being displaced in an inclined direction even when the positions where the support portions 412 support the diaphragm portion 20A are shifted in the long-side direction from the center.

As described above, while achieving an effect similar to that of the configuration in which the one support portion 411 extends in the long-side direction, Embodiment 3 facilitates bending of the diaphragm portion 20A compared with this configuration, thus enabling an increase in the accuracy of pressure detection.

Freely selected embodiments of the various embodiments can be combined as appropriate. Thus, it is possible to achieve effects of the embodiments.

In the various embodiments, a pressure sensor device may have only one or some of the features of the pressure sensor device according to the present disclosure.

For example, a pressure sensor device may have the feature in which a diaphragm portion has a rectangular shape when viewed in a thickness direction without the feature in which a movable portion is provided in an internal space defined by the diaphragm portion, a substrate layer, and a side wall portion. In this case, an aspect of the pressure sensor device can comprise: a membrane layer including a diaphragm portion; a substrate layer that faces and is spaced from the membrane layer in a thickness direction; and an intermediate layer located between the membrane layer and the substrate layer, wherein the membrane layer further includes an electrode portion provided to the diaphragm portion, the intermediate layer includes a side wall portion joined to the substrate layer and the membrane layer, and a conductive movable portion provided apart from the side wall portion, the movable portion facing and being spaced from the electrode portion in the thickness direction, the movable portion being configured to be moved by displacing the diaphragm portion while being supported by a part of the diaphragm portion different from the electrode portion, and the diaphragm portion has a rectangular shape when viewed in the thickness direction.

In such a pressure sensor device, the first intermediate layer 30 is included in the membrane layer 20, and the second intermediate layer 40 is an example of the intermediate layer.

The present disclosure is fully described through the preferred embodiments with reference to the drawings as appropriate. However, it is obvious to those skilled in the art that various alterations and modifications thereof can be made. It should be understood that such alterations and modifications are included in the present disclosure without departing from the scope of the present disclosure as defined by the appended claims.

### Reference Signs List

10 pressure sensor device

20 membrane layer

20A diaphragm portion

20B diaphragm portion

30 first intermediate layer

32 electrode portion

33 guard portion

40 second intermediate layer

40A internal space

40B internal space

41 movable portion

411 support portion

412 support portion

42 side wall portion

50 substrate layer

What is claimed is:

1. A pressure sensor device comprising:
a membrane layer including a diaphragm portion;
a substrate layer that faces and is spaced from the membrane layer in a thickness direction;
a first intermediate layer between the membrane layer and the substrate layer; and
a second intermediate layer between the first intermediate layer and the substrate layer, wherein
the first intermediate layer includes:
an electrode portion between the diaphragm portion and the second intermediate layer, and
a guard portion joined to a part of the membrane layer different from the diaphragm portion and electrically insulated from the electrode portion, and
the second intermediate layer includes:
a side wall portion joined to the substrate layer and the guard portion, and
a conductive movable portion supported by the diaphragm portion, apart from the substrate layer and the side wall portion, positioned in an internal space defined by the diaphragm portion, the substrate layer, and the side wall portion, the conductive movable portion facing and spaced from the electrode portion in the thickness direction, the conductive movable portion configured to be moved when the diaphragm portion is displaced.

2. The pressure sensor device according to claim 1, wherein the electrode portion is joined to the diaphragm portion.

3. The pressure sensor device according to claim 1, wherein
the electrode portion is apart from the diaphragm portion, and
a part of the electrode portion that does not face the conductive movable portion in the thickness direction is supported by the side wall portion.

4. The pressure sensor device according to claim 1, wherein the diaphragm portion supports the conductive movable portion at a position where a displacement amount of the diaphragm portion when a pressure is applied to the diaphragm portion is maximum.

5. The pressure sensor device according to claim 1, wherein the internal space is a sealed space.

6. The pressure sensor device according to claim 1, wherein the diaphragm portion has a rectangular shape when viewed in the thickness direction.

7. The pressure sensor device according to claim 6, wherein the conductive movable portion includes a support portion that is supported by the diaphragm portion, the support portion having a linear shape extending in a long-side direction of the diaphragm portion having the rectangular shape when viewed in the thickness direction.

8. The pressure sensor device according to claim 7, wherein a value obtained by dividing a length of a long side of the rectangular shape of the support portion by a length of a long side of the rectangular shape of the diaphragm portion is 0.1 to 0.75.

9. The pressure sensor device according to claim 6, wherein
the conductive movable portion includes a plurality of support portions each of which is supported by the diaphragm portion, and
the plurality of support portions are arranged spaced from each other in a long-side direction of the diaphragm portion having the rectangular shape when viewed in the thickness direction.

10. The pressure sensor device according to claim 6, wherein a value obtained by dividing a length of a long side of the diaphragm portion having the rectangular shape when viewed in the thickness direction by a length of a short side of the diaphragm portion is two or more.

11. The pressure sensor device according to claim 10, wherein the value obtained by dividing the length of the long side of the diaphragm portion having the rectangular shape when viewed in the thickness direction by the length of the short side of the diaphragm portion is three or more.

12. The pressure sensor device according to claim 6, wherein
the membrane layer includes a plurality of the diaphragm portions,
a plurality of the internal spaces are defined by each of a corresponding one of the plurality of diaphragm portions,
the first intermediate layer includes a plurality of the electrode portions each in a corresponding one of the internal spaces,
the second intermediate layer includes a plurality of the conductive movable portions each in a corresponding one of the internal spaces, and configured to be moved by displacing a respective diaphragm portion of the plurality of diaphragm portions that are supporting the plurality of the conductive movable portions, and
the plurality of diaphragm portions each having the rectangular shape when viewed in the thickness direction are arranged in a short-side direction of the rectangular shape such that respective long sides of the rectangular shapes of adjacent two of the diaphragm portions face each other.

13. The pressure sensor device according to claim 12, wherein the plurality of internal spaces communicate with each other.

14. The pressure sensor device according to claim 12, wherein the plurality of electrode portions are joined to the respective diaphragm portion of the plurality of diaphragm portions.

15. The pressure sensor device according to claim 12, wherein
the plurality of electrode portions are apart from the plurality of diaphragm portions, and
a part of the plurality of electrode portions that do not face the plurality of conductive movable portions in the thickness direction are supported by the side wall portion.

16. The pressure sensor device according to claim 12, wherein the plurality of diaphragm portions support the corresponding one of the conductive movable portions at a position where a displacement amount of the plurality of diaphragm portions when pressure is applied to the plurality of diaphragm portions is maximum.

17. The pressure sensor device according to claim 12, wherein the plurality of internal spaces are a sealed space.

18. The pressure sensor device according to claim 12, wherein each of the conductive movable portions include a support portion that is supported by a respective one of the plurality of diaphragm portions, the support portion having a linear shape extending in a long-side direction of the plurality of diaphragm portions having the rectangular shape when viewed in the thickness direction.

19. The pressure sensor device according to claim 18, wherein a value obtained by dividing a length of a long side of the rectangular shape of the plurality of support portions by a length of a long side of the rectangular shape of the plurality of diaphragm portions is 0.1 to 0.75.

20. The pressure sensor device according to claim 12, wherein
the plurality of conductive movable portions each include a plurality of support portions, each of the plurality of support portions of a respective conductive moveable portion is supported by a respective one of the plurality of diaphragm portions, and
the plurality of support portions of the respective conductive moveable portion are arranged spaced from each other in a long-side direction of the respective one of the plurality of diaphragm portions having the rectangular shape when viewed in the thickness direction.
